(19) United States
(12) Patent Application Publication
(10) Pub. No.: US 2026/0088426 A1
(43) Pub. Date: Mar. 26, 2026

(54) ELECTRIC-VEHICLE BATTERY CARRIER PRODUCED IN A CASTING PROCESS

(71) Applicant: Ford Global Technologies, LLC, Dearborn, MI (US)

(72) Inventors: Raphael Koch, Odenthal (DE); Maik Broda, Würselen (DE); Ilya Popov, Aachen (DE)

(73) Assignee: Ford Global Technologies, LLC, Dearborn, MI (US)

(21) Appl. No.: 19/341,602

(22) Filed: Sep. 26, 2025

(30) Foreign Application Priority Data
Sep. 26, 2024 (DE) 10 2024 127 885.4

(51) Int. Cl. H01M 50/249; B22D 17/00; H01M 10/42; H01M 10/613; H01M 10/615; H01M 10/655; H01M 50/244; H01M 50/262

(52) U.S. Cl. CPC H01M 50/249; B22D 17/007; H01M 10/425; H01M 10/613; H01M 10/615; H01M 10/655; H01M 50/244; H01M 50/262

(57) ABSTRACT

A method or process for producing a battery carrier for an electric vehicle, which receives battery cells. The battery carrier is produced in a casting process, such as a rheocasting process.

### CROSS-REFERENCE TO RELATED APPLICATION

This application claims priority to and the benefit of German Patent Application No. 102024127885.4, filed on Sep. 26, 2024. The disclosure of the above application is incorporated herein by reference.

### FIELD

The present disclosure relates to a process for producing a battery carrier for an electric vehicle

### BACKGROUND

The statements in this section merely provide background information related to the present disclosure and may not constitute prior art.

When producing battery carriers, these are generally made up of individual metal profiles that are welded together. With this process, a multiplicity of individual parts are produced, stored, transported and made available for the welding process. Above all, the subsequent welding process is time-consuming. In addition, in this type of production tight tolerances are desired to provide the correct fit and performance of the battery to be inserted into the battery carrier or the individual cells of the battery. The large number of welding processes and complex geometry make this process inconvenient. Moreover, a large number of sealants and adhesives are desired to ultimately provide a leakage-free and high-strength assembly. In addition, the assembly lines use a lot of space in the production shop, increasing the production area and capital investment.

Another aspect is the cooling device, often designed as a cooling plate, which is desired for cooling the battery during the operation of the electric vehicle and which is generally produced separately and connected to the battery carrier. This separate production step increases the complexity and leads to additional manufacturing processes.

Given the above, although the production of the battery carrier in a casting process does fundamentally offer an alternative solution, it is used principally for relatively small PHEV (Plug-In Hybrid Electric Vehicle) batteries. Among the limitations of the casting of battery carriers, especially full-size battery trays, are dimensional accuracy, strength and complexity as regards the large-scale integration of cooling systems and other functions.

### SUMMARY

This section provides a general summary of the disclosure and is not a comprehensive disclosure of its full scope or all of its features.

The present disclosure provides a process for producing a battery carrier for an electric vehicle, for receiving battery cells, wherein the battery carrier is produced in a casting process.

The disclosure discloses a process for producing a battery carrier for an electric vehicle, for receiving battery cells, wherein the battery carrier is produced in a casting process. According to the disclosure, the battery carrier is produced in a rheocasting process.

It should be noted that the features and measures presented individually in the following description can be combined in any technically feasible manner and indicate further refinements of the disclosure. The description additionally characterizes and specifies the disclosure particularly in conjunction with the figures.

The use of the rheocasting process, particularly for large battery carriers, not only refines the filling process on account of the specific rheology of the molten alloy, in order to fill smaller cavities and achieve thinner walls, but also makes it possible, for example, to use diecasting machines with very low tonnages since the pressure for filling the cavities is significantly lower. Battery carriers can have dimensions of 1.0*1.5 m (L*B) to 1.5*2.0 m, for example, where large battery carriers are concerned. However, the stated dimensions are not intended to have a limiting effect. Other dimensions are also conceivable and possible. Moreover, the wall thickness dimensions can be reduced in comparison with battery carriers produced in high pressure diecasting processes while nevertheless satisfying the applicable standards in respect of mechanical and other properties. Thinner walls can be reproduced by virtue of the longer specific flow length of the partially solidified melt, it being possible to reduce walls to a thickness of 2-6 mm. Here, the position of the relevant element with respect to the sprue may be taken into account as an influencing factor.

The rheocasting process is a special casting process in which a light metal material, e.g. aluminum, is processed not in the fully liquid state, as in conventional casting processes, but in the semi-solid, i.e. semi-solidified or semi-liquid state.

In contrast to conventional diecasting, in which dendritically solidified α-aluminum grains are characteristic of the microstructure, prior controlled cooling of the casting melt and a stirring motion lead to the formation in the rheocasting process of round grains (“globulites”). These grains refines flowability during the filling of the casting mold and the supply of additional material during solidification. Since the casting melt to be processed is solidified to a certain extent even before the casting mold is filled, it is possible to reduce solidification cavities and distortion of the battery carrier. Moreover, the high viscosity of the melt inhibits turbulence and thus gas inclusions, which, as pores, make up the greatest and unwanted proportion of casting issues in conventional casting processes. By virtue of the good filling and solidification properties, both thin-walled and thick-walled structures of the battery carrier can be achieved. In other words, this means that the material is used only at the location where it is important for the functionality of the battery carrier. Together with the good mechanical properties, it is possible in this way to realize a considerable potential for lightweight construction of the battery carrier for the electric vehicle.

Another known process in addition to the rheocasting process is the closely related process of “thixocasting”, which is likewise based on processing metal in a pasty state. In thixocasting, however, there is the disadvantage of using pre-produced bar stock, whereas the rheocasting process involves working directly with the liquid, i.e. semi-solidified, melt, and in addition there is expediently the choice of an alloy which ideally may not use heat treatment after processing since a battery carrier should normally also have a high strength. Thanks to the use of the rheocasting process according to the disclosure, it is possible to use a smaller diecasting machine with a lower clamping force than with the conventional diecasting process. Another advantage of the rheocasting process using partially solidified (aluminum) melt can be seen in the configuration of the gating system. Owing to the higher viscosity of the partially solidified melt, the gating system can be of simpler configuration. Because of the partially solidified melt, it is furthermore possible to reduce turbulence during mold filling, allowing less complex gates. Since the melt is already partially solidified, the supply of additional material is reduced, allowing smaller sprue cross sections.

The rheocasting process is therefore a semi-solid metal casting process, which offers several advantages in comparison with conventional casting processes. The following advantages may be mentioned:

Increased mechanical properties, increased stability of the battery carrier.

A significantly higher strength of the battery carrier since finer microstructures are produced in rheocasting processes, leading to increased mechanical properties, such as higher tensile strength and yield strength.

Increased ductility since this rheocasting process reduces porosity, leading to better ductility and fatigue resistance of the battery carrier when used in an electric vehicle.

Fewer gas inclusions lead to lower porosity since the semi-solid state of the metal reduces the probability of gas inclusions, leading to lower porosity. In addition, the controlled solidification process reduces shrinkage. In general, slightly increased thermal conductivity in comparison with conventional diecast components may be expected. This is due to the microstructure and also to the reduced porosity, each of which can be achieved by means of the expedient rheocasting process according to the disclosure.

The use of the rheocasting process furthermore leads to increased dimensional accuracy of the battery carrier on account of tighter tolerances since the rheocasting process allows the production of battery carriers with tighter dimensional tolerances, thereby reducing the desire for finish machining after casting. This also leads to consistency because this rheocasting process enables more uniform and repeatable production of battery carriers, thereby providing the uniformity of the end products.

Use of this process furthermore leads to enhanced surface finish with smoother surfaces since the battery carriers which are produced in the rheocasting process have a better surface finish than those which are produced by conventional casting processes. This also advantageously makes lower demands on the machining process since the enhanced surface finish reduces or entirely eliminates the desire for extensive machining and finish machining after casting.

It is furthermore possible to achieve material savings, in particular because of less waste of material. By means of the rheocasting process, it is possible to produce battery carriers that are close to net shape, reducing the waste of material. There is efficient use of raw materials since the process enables the efficient use of high performance alloys.

Another significant advantage is energy efficiency. This is because the rheocasting process is carried out at lower temperatures in comparison with conventional casting processes, leading to energy savings. These lower temperatures also reduce the thermal loading of the casting molds for the battery carrier and of the casting plants, and extend their service life.

It is possible to achieve great versatility with a wide range of materials since the rheocasting process can be used for a large number of light metal materials and alloys thereof, including, for example, aluminum, magnesium and other nonferrous metals.

The process is surprisingly and advantageously suitable for the production of the complex and complicated geometries of the battery carrier, which is difficult to achieve with other casting processes.

Finally, the rheocasting process has advantages for the environment, such as lower emissions (the reduced energy consumption and waste of material contribute to lower greenhouse gas emissions) and sustainable production since the efficient use of raw materials and the reduced desire for secondary machining during the production of battery carriers make the rheocasting process a sustainable manufacturing process in connection with electric vehicles.

In a further refinement, at least one holder for battery cells that are inserted into the battery carrier is produced by the rheocasting process. This holder can likewise be produced by the rheocasting process as a separate component or as an integral part of the battery carrier. As a result, the holder is either produced together with the battery carrier in a single step, or the holder for the battery cells is produced in just two steps.

In a further refinement, at least one opening is produced in the battery carrier by the rheocasting process. This opening can involve openings for passing through electric connections, plug connectors, cables, sensors, valves or the like. With the production of the battery carrier, the at least one opening is thus directly present, enabling it to be made available directly for further assembly without performing drilling work.

In a further refinement, at least one central support for various types of battery cells is produced by the rheocasting process. This central support, which is, in one example, situated precisely on the longitudinal axis, or alternatively directly adjacent thereto, increases the stability of the battery carrier and delimits the individual battery cells that are inserted into the battery carrier. With the use of the rheocasting process according to the disclosure, the central support can be readily adapted by appropriate shaping of the casting mold to the respective geometrical design.

In a further refinement, at least one cooling device is produced by the rheocasting process. It is thereby advantageously possible to connect the cooling device directly to the battery carrier and/or integrate it into the latter after the production of the battery carrier. Depending on the configuration of the cooling device, this is produced as an integral part of the battery carrier or separately therefrom. This increases flexibility in the production and assembly of the battery carrier.

In a further refinement, at least one heating device is produced by the rheocasting process. It is thereby advantageously possible to connect the heating device directly to the battery carrier and/or integrate it into the latter after the production of the battery carrier. Depending on the configuration of the heating device, this is produced as an integral part of the battery carrier or separately therefrom. This increases flexibility in the production and assembly of the battery carrier.

In a further refinement, at least one reinforcement and/or at least one guide element and/or at least one fastening point are/is produced by the rheocasting process. By appropriate configuration of the casting mold, it is possible to reproduce reinforcements and/or guide elements and/or fastening points in this casting mold, such that these are obtained in the battery carrier after the rheocasting process has been carried out. Reinforcements in the battery carrier increase its stability, while guide elements are used for the targeted insertion of battery cells into the battery carrier. Fastening points are helpful for fastening the battery cells in the battery carrier. Alternatively or in addition, they can also be used for a closure (lid) of the battery carrier, with the result that a battery housing is then formed. Normally, the battery carrier is closed with a lid, which is entirely expedient in respect of sealing, electric insulation and/or heat management, to name just a few advantages of the lid, which are not intended to be restrictive. In a further possible refinement, the battery carrier can be arranged on the vehicle in such a way that an upper side opposite a base does not have to be closed with a lid. It is conceivable for the battery carrier to be secured on a floor of the vehicle, for which purpose suitable fastening elements can be provided directly by means of the rheocasting process according to the disclosure, i.e. can be molded onto the battery carrier.

In a further refinement, at least one sensor installation space is produced in the battery carrier by the rheocasting process. After the production of the battery carrier, sensors can be inserted and installed in this sensor installation space in order to detect corresponding operating parameters of the battery cells, e.g. temperatures and the like, and to transmit them to a downstream control unit.

In other words, the rheocasting process and casting molds used for this purpose can be configured and implemented in such a flexible way that battery carriers with integrated cooling channels, with openings for electric connections and valves, with a central support (ribs) for various types of battery cells, with a honeycomb body for cylindrical battery cells, with ribs for pouch and prismatic battery cells, with holders and fastening points, with holders for cables, with vent holes and ventilation systems, with an external coolant connection for the case of a thermal runaway and the like can be obtained with the advantages described above. In addition, the integration of sensors, e.g. temperature sensors, in the cooling channels for the purpose of monitoring the battery temperature in real time is possible in this way, as is the integration of electric cables and plugs for simpler assembly processes. These components are normally installed after the casting process. However, it is within the scope of the disclosure if the cables are inserted directly into the casting mold and embedded. In order to provide thermal protection for the cables during the filling process and to provide guidance within the mold, the inserted cables can be present in a tube (aluminum extruded or extrusion profile), for example.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of a structure of a battery carrier according to one form of the present disclosure; and

FIG. 2 shows a schematic illustration of a structure of a battery carrier according to one form of the present disclosure.

In the various figures, identical parts are always provided with the same reference signs, for which reason these are also generally described only once.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

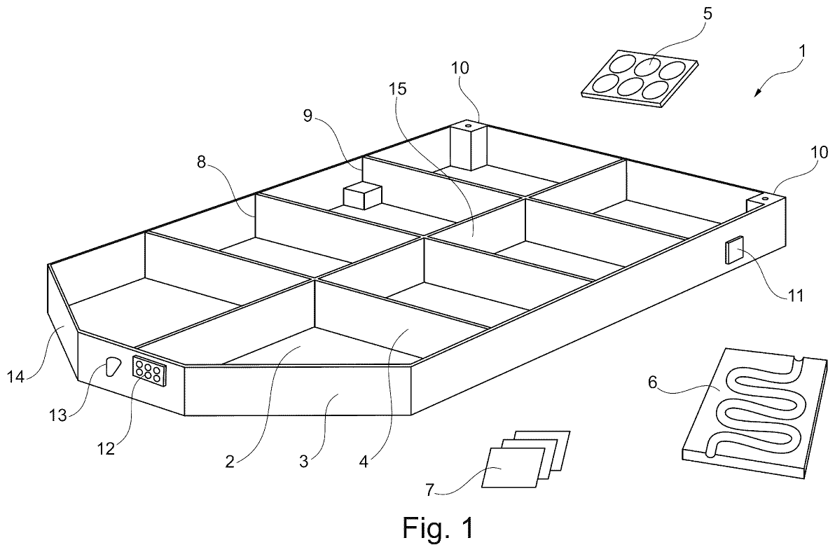

FIG. 1 shows an illustrative structure of a battery carrier 1 which has been produced using the rheocasting process according to the disclosure. This battery carrier 1 has a base 2 which is substantially flat, for example, from which there extends a side wall 3, in one example, a side wall 3 which fully encircles the lateral edge of the base 2. Extending from the encircling side wall 3 in the direction of the inner region of the battery carrier 1 there can be partition walls 4, which form receiving spaces for battery cells (in the manner of a box) of the battery carrier 1, into which the respective battery cells (not illustrated here) are inserted. A battery-cell holder 5 can be placed on the base 2 and therefore inserted into the battery carrier 1. In this example, this holder has honeycomb recesses and, by way of example, is matched to the configuration of the box for receiving the battery cell. Other geometrical designs are of course conceivable. A cooling device 6 can likewise be inserted into the battery carrier 1. In the example, the cooling device 6 is shown as a separate component which can be inserted into the battery carrier 1. In addition, it is conceivable for the cooling device 6, e.g. in the form of cooling spaces or cooling channels, to be integrated directly in advance into the base 2 and/or the side wall 3 and/or the partition wall 4 during the casting of the battery carrier 1. The same applies to a heating device 7, which is likewise shown as a separate component here. It is equally possible for it to be integrated into the battery carrier 1. The battery carrier 1 can be closed with a lid. This lid can be manufactured from a plastic or a flat aluminum sheet.

In addition, the battery carrier 1 has (schematically illustrated) reinforcements 8, which can be provided not only at the location shown but also at additional or other locations within the battery carrier 1. The same applies to guide elements 9. Fastening points 10 can be produced by the rheocasting process, in one example, in the corner regions of the battery carrier 1 if the latter has an approximately polygonal cross section. In addition, the battery carrier 1 can optionally have at least one ventilation port 11, to which a corresponding ventilation feed is connected in order to cool and/or heat the interior of the battery carrier 1 during its operation in the electric vehicle, depending on what is desired at any given moment. Also shown is an interface 12, which can be provided in order, for example, to introduce cables, sensors, plug connectors or the like into the interior of the battery carrier 1. There can likewise be at least one ventilation opening 13, by means of which passive cooling and/or heating of the interior of the battery carrier 1 can be performed. At least one sensor installation space 14 is integrated by means of the rheocasting process for the production of the battery carrier 1 in order to enable at least one sensor for detecting the operating parameters of the battery cells inserted into the battery carrier 1 to be arranged there. In the case of the approximately rectangular example of the battery carrier 1 shown in FIG. 1, a central support 15 has been produced approximately on the longitudinal axis of the carrier by means of the rheocasting process. From this, the partition walls 4 extend in the direction of the side wall 1 and thus form the already described kind of box (receiving space) for the battery cells. The central support 15 can also contain cooling spaces, cooling channels or the like.

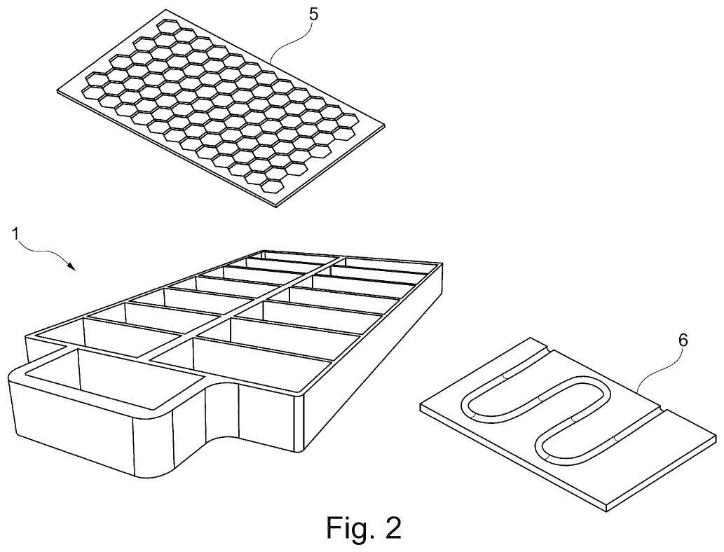

FIG. 2 shows another schematic structure of a battery carrier 1, wherein it can be seen that the battery carrier 1 has a plurality of battery-cell receiving spaces arranged one behind the other next to the central support 15, and wherein just a single such receiving space is present at one end of the battery carrier 1. It furthermore shows that a separate holder 5 for battery cells, and the cooling device 6 (and/or the heating device 7, not illustrated here) can be inserted into the battery carrier 1.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a battery carrier for an electric vehicle, for receiving battery cells, the method comprising:
rheocasting the battery carrier.

2. The method according to claim 1, further comprising:
rheocasting at least one holder for battery cells that is inserted into the battery carrier.

3. The method according to claim 1, further comprising:
rheocasting at least one opening in the battery carrier.

4. The method according to claim 1, further comprising:
rheocasting at least one central support in the battery carrier for the battery cells.

5. The method according to claim 1, further comprising:
rheocasting at least one cooling device.

6. The method according to claim 5, wherein the at least one cooling device is integrally formed with the battery carrier.

7. The method according to claim 5, wherein the at least one cooling device is separate from the battery carrier.

8. The method according to claim 1, further comprising:
rheocasting at least one heating device.

9. The method according to claim 8, wherein the at least one heating device is integrally formed with the battery carrier.

10. The method according to claim 8, wherein the at least one heating device is separate from the battery carrier.

11. The method according to claim 1, further comprising:
rheocasting at least one of at least one reinforcement, at least one guide element, and at least one fastening point.

12. The method according to claim 1, further comprising:
rheocasting at least one sensor installation space in the battery carrier.

13. A method for producing a battery carrier for an electric vehicle, for receiving battery cells, the method comprising:
rheocasting the battery carrier,
rheocasting at least one holder for battery cells that is inserted into the battery carrier;
rheocasting at least one opening in the battery carrier;
rheocasting at least one central support in the battery carrier for the battery cells;
rheocasting at least one cooling device; and
rheocasting at least one heating device.

14. The method according to claim 13, wherein the at least one cooling device is an integral part of the battery carrier.

15. The method according to claim 13, wherein the at least one cooling device is separate from the battery carrier.

16. The method according to claim 13, wherein the at least one heating device is an integral part of the battery carrier.

17. The method according to claim 13, wherein the at least one heating device is separate from the battery carrier.

18. The method according to claim 13, further comprising:
rheocasting at least one of at least one reinforcement, at least one guide element, and at least one fastening point.

19. The method according to claim 13, further comprising:
rheocasting at least one sensor installation space in the battery carrier.

20. A method for producing a battery carrier for an electric vehicle, for receiving battery cells, the method comprising:
rheocasting the battery carrier,
rheocasting at least one holder for battery cells that is inserted into the battery carrier;
rheocasting at least one opening in the battery carrier;
rheocasting at least one central support in the battery carrier for the battery cells;
rheocasting at least one cooling device;
rheocasting at least one heating device;
rheocasting at least one of at least one reinforcement, at least one guide element, and at least one fastening point; and
rheocasting at least one sensor installation space in the battery carrier.
